(19) United States
(12) Patent Application Publication
(10) Pub. No.: US 2006/0181068 A1
(43) Pub. Date: Aug. 17, 2006

(54) Reclining back with anti-tip protection for wheelchairs

(76) Inventors: John E. Bennett, Rancho Palos Verdes, CA (US); Willis C. Bradley, Gardena, CA (US); Leah Rotter, Los Angeles, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 11/300,521

(22) Filed: Dec. 13, 2005

Related U.S. Application Data
(63) Continuation-in-part of application No. 10/692,830, filed on Oct. 23, 2003, now abandoned.

(51) Int. Cl. B62H 7/00; B62D 49/08

(52) U.S. Cl. 280/755; 280/304; 280/304.1

(57) ABSTRACT

A wheelchair has a seat, a reclining backrest and anti-tip legs movable between a retracted position and an extended ground contacting position in response to movement of the backrest between an upright and a reclining condition. The inclination of the backrest can be conveniently adjusted by a person seated in the wheelchair by latching a pair of detent arms in one of several slots spaced under the chair's armrests. The anti-tip legs extend to support the wheelchair against tipping backwards when the backrest is reclined and retract out of the way when the backrest is brought upright.

This is a Continuation-in-part of Ser. No. 10/692,830 filed Apr. 3, 2003

### BACKGROUND OF THE INVENTION

1. Field of the Invention

This invention pertains generally to the field of seats and chairs with reclining backs and in particular to reclining backs with anti-tip protection for wheelchairs.

2. State of the Prior Art

Wheelchairs have been equipped with reclining backs in the past, and it is known to provide restraints against rearward tipping of the chair. The previous reclining backs and anti-tipping restraints were not operable by the wheelchair occupant. What is needed is a reclining backrest operable by a user seated in the wheelchair with anti tipping restraints automatically deployed in response to movement of the backrest.

### SUMMARY OF THE INVENTION

A wheelchair having a wheelchair frame including a seat supported on the frame has a backrest which is pivotable on the frame between an upright position and a reclined position. A pair of rear wheels are journaled to the frame for rotation about a rear wheel axis, and a pair of anti-tip legs are attached to the frame and movable between a retracted position and an extended position for contacting a ground surface behind the rear wheel axis in response to pivoting movement of the backrest.

The wheelchair frame may have a pair of armrests and a detent plate is provided along one of the armrests, the detent plate having a slot including a plurality of detent notches open to the slot. A detent arm can be attached to the backrest, the detent arm having a forward end captive for displacement along the slot and engageable in any one of the detent notches for detaining the backrest at one or more positions intermediate to the upright position and the reclined position. Preferably, a handgrip is provided on the forward end of the detent arm.

The backrest, the legs and the detent arm may be spring biased towards the upright position, the retracted position and a forwardmost position, respectively. For example, the anti-tip legs can be spring loaded towards their retracted position such that the spring force acting on the detent arm and on the anti tip legs tends to return the backrest to its upright position when the detent arm is released from the detent notch.

In a presently preferred form of the invention a pair of linkage arms are pivoted to the wheelchair frame, the backrest being supported on the linkage arms for pivotal movement therewith relative to the wheelchair frame, and the linkage arms are connected for moving the legs between the retracted position and extended position responsive to pivoting movement of the backrest. A mounting plate may be fastened to each side of the wheelchair frame, and a linkage arm pivoted to each mounting plate.

In a particular embodiment of the invention the anti tip legs are mounted for generally vertical movement on the wheelchair frame and the backrest has linkage arms connected for urging the legs downwardly into ground contacting position responsive to rearward pivoting of the backrest. The legs may be vertically slidable through leg holders fastened to the wheelchair frame. The leg holders may be removably fastened to the wheelchair frame on a pair of bottom tubes of the wheelchair frame terminating in rear ends behind the rear wheel axis. The leg holders may be in the form of holder sleeves fitted to the rear ends of the bottom tubes provided with sleeve fasteners for releaseably securing the holder sleeves to the rear ends.

The reclining backrest can be removably attached to the wheelchair frame to allow folding of the wheelchair frame or replacement of the reclining backrest with a non-reclining backrest.

These and other improvements, features and advantages will be better understood by reference to the following detailed description of the preferred embodiments taken in conjunction with the accompanying drawings.

### BRIEF DESCRIPTION OF THE DRAWINGS

FIG. 1 is a left side view of a wheelchair provided with a reclining backrest with anti-tip protection according to this invention, showing the backrest in upright position and the anti-tip legs in retracted position;

FIG. 2 is a side view as in FIG. 1 but showing the backrest in reclined position and the anti-tip legs in ground contacting extended position;

FIG. 3 is a detail perspective view of the wheelchair of FIG. 1 showing the left side mounting of the backrest on a pivoting linkage arm, the attachment of the linkage arm for actuating the left anti-tip leg and the rear end of the detent arm connected to the backrest;

FIG. 4 is a side view of the detent plate mounted under the left arm rest and showing forward end of the detent arm captive in the slot of the detent plate with a spring connected between the detent arm and the detent plate for urging the detent arm into engagement with the detent notches along the slot;

FIG. 5 is a detail cross-sectional view taken along line 5-5 in FIG. 4 illustrating the handgrip on the captive forward end of the detent arm; and

FIG. 6 is a detail view showing how the left linkage arm is pivoted to the left side mounting plate and how the removable backrest is supported on the linkage arm.

### DETAILED DESCRIPTION OF THE PREFERRED EMBODIMENT

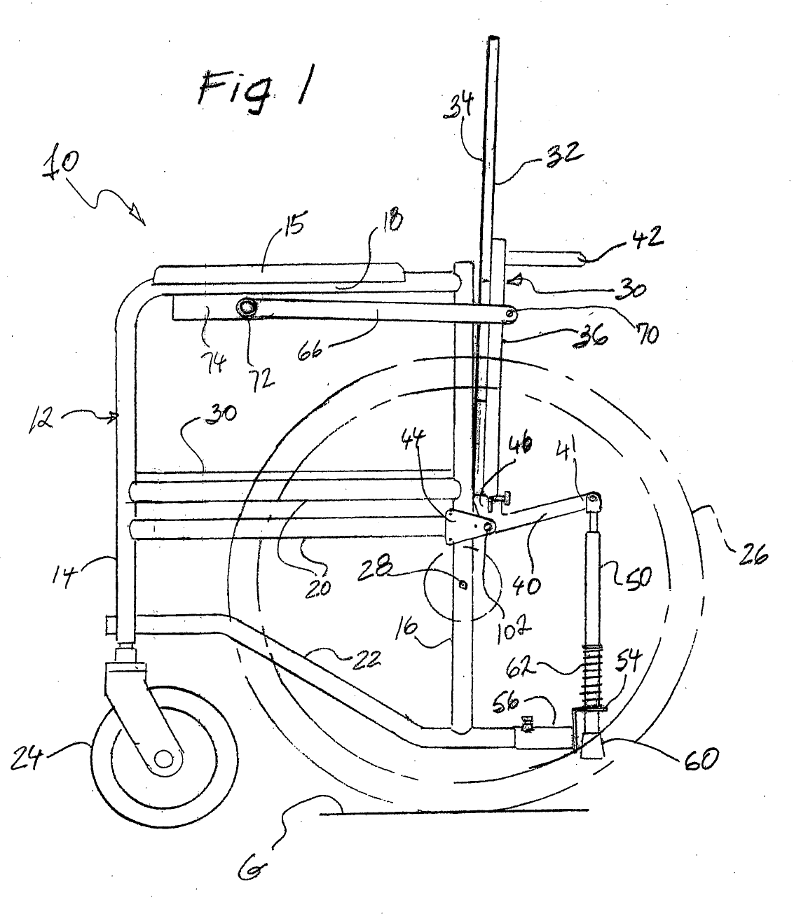

With reference to the drawings wherein like elements are designated by like numerals, FIG. 1 shows a wheelchair generally designated by numeral 10 having a wheelchair frame 12 which generally consists of a tubular framework including a pair of front legs 14, a pair of rear legs 16, left and right side arm rests 15 supported on side arm tubes 18 connecting the top ends of the front and rear legs 14, 16, a pair of seat carrier tubes 20 on each side of the wheelchair frame 12 connecting the front and rear legs 14, 16 at a mid height level, and a bottom tube 22 which connects the lower ends of each front leg 14 and the corresponding rear leg 16. The wheelchair also has a pair of front caster wheels 24 mounted to the lower ends of the front legs 14, and a pair of larger rear wheels 26 journaled to the wheel chair frame 12 for rotation about a rear wheel axis 28. A wheelchair seat 30 is supported between the left and right seat supports 20.

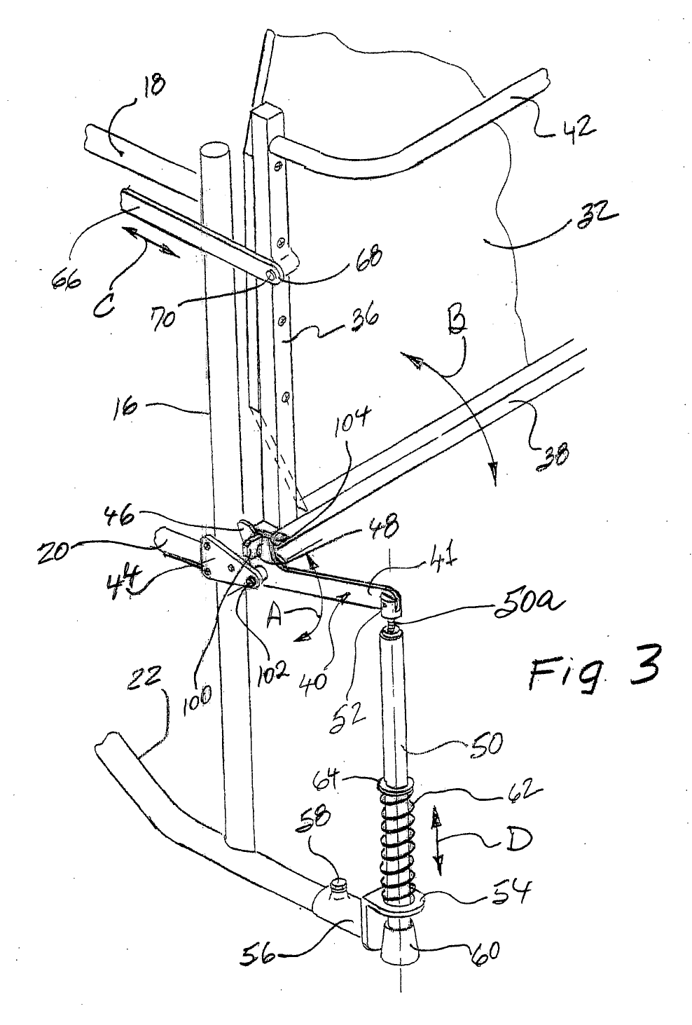

A reclining backrest generally designated by numeral 30 has a seat back 32 which may have a padded or cushioned front 34 and is fastened to a frame consisting of left and right posts 36 and a cross rail 38 which extends across the lower end of the seat back 32, as best seen in FIG. 3. The upper ends of the vertical posts 36 are connected by a handle bar 42.

The backrest 32 is supported on linkage arms 40, in a manner which will be explained in greater detail below, and which in turn are pivoted to mounting plates 44 fastened to the rear legs 16. Each linkage arm 40 has a short upright arm portion 46 into which is cut a receiving slot 48. One linkage arm 40 is mounted on each of the left and right rear legs 16 of the arm chair 12, and while FIG. 3 shows only the left side linkage arm and corresponding mounting plate 42, the right hand side arrangement of linkage arm 40 and anti-tip leg 50 not shown in FIG. 3 is essentially a mirror image of the illustrated left side.

An anti-tip leg 50 is suspended from the rear end 41 of each linkage arm 40 in generally vertical position and approximately parallel to the rear leg 16 of the wheelchair frame by a pivotal connection 52 between the upper end of the leg 50 and the rear end 41 of linkage arm 40. The lower portion of leg 50 slides through a guide ring portion 54 of leg holder 56, which is a tubular sleeve fitted onto the rear end of bottom tube 22 of the wheelchair frame, and is fastened in place by a set screw 58. A rubber tip 60 may be fitted onto the bottom end of the leg 50. The leg 50 is biased upwardly towards a retracted position by coil spring 62 compressed between guide ring 54 and a washer 64 fixed on leg 50.

FIG. 3 shows part of a detent arm 66 which has a rear end 68 pivotably attached to vertical post 36 of the backrest by a retractable pin 70. Turning to FIG. 4, a detent plate 74 is mounted along the underside of armrest tube 18 and has a horizontal slot 76 with a number of detent notches 78 open to the slot 76, and detent arm 66 has a forward end 72 captive for movement within slot 76.

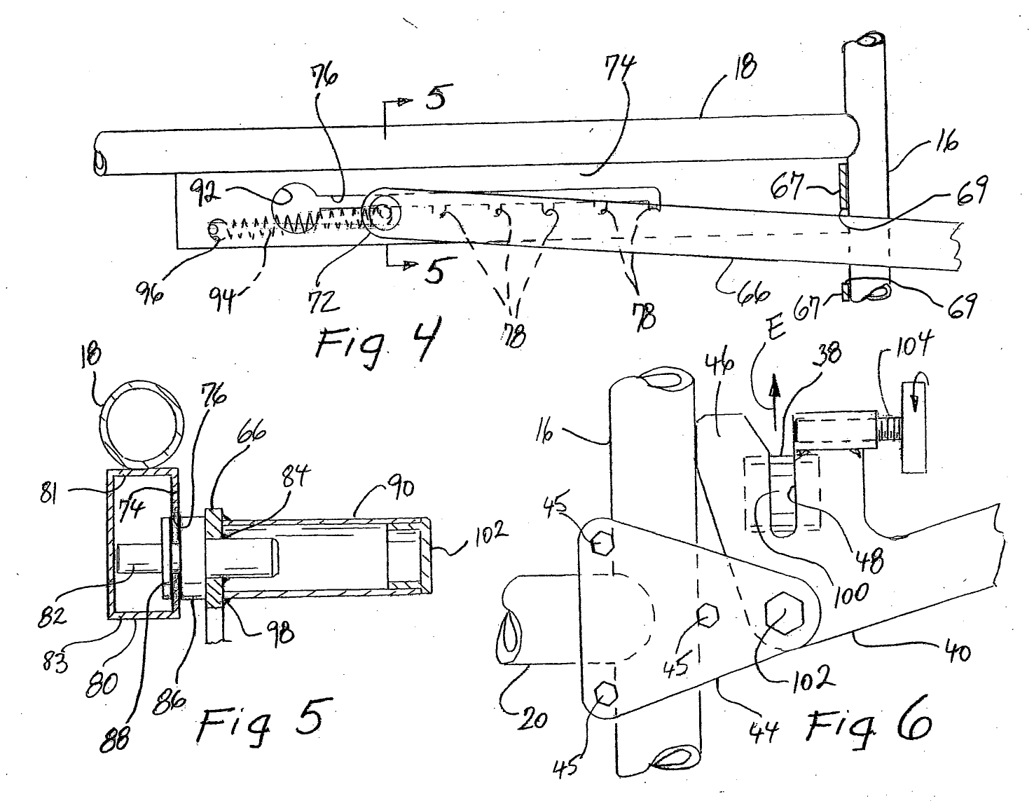

FIG. 5 shows how the detent arm 66 is retained to the plate 74. As seen in FIG. 5, detent plate 74 is a side wall of a detent tube 80 of rectangular cross section. A pin 82 is secured to detent arm 66 as by welding at 84, and carries a spacer ring 86 and a retaining disc 88 The disc 88 has a disc diameter greater than the width of slot 76 except at an enlarged end opening 92 provided at the forward end of slot 76. The enlarged opening 92 admits the retaining disc 88 into the detent tube 80 and permits engagement of the pin 82 for sliding displacement along slot 76. The diameter of pin 82 within slot 76 is admitted into any one of detent notches 78 so as to detain the forward end 72 of arm 66 at a selected detent notch 78 against displacement along slot 76. A detent spring 94 is stretched between pin 82 and anchor hole 96 in the detent tube 80 and applies a spring bias urging detent arm 66 into engagement with any of the detent notches 78 underlying pin 82 of the forward end of detent arm 66. A guide plate 67 is welded to leg 16 under side arm tube 18, and detent arm 66 passes through guide slot 69 cut in plate 67, as seen in FIGS. 3 and 4. Slot 69 helps keep the detent arm 66 in slot 76.

A handgrip 90 is fastened as by welding at 98 to the forward end of detent arm 66. The handgrip may be a short cylindrical section closed at its free end by cap 102, and is located so as to be conveniently within grasp of a person seated in the wheelchair, well forward of the backrest 32.

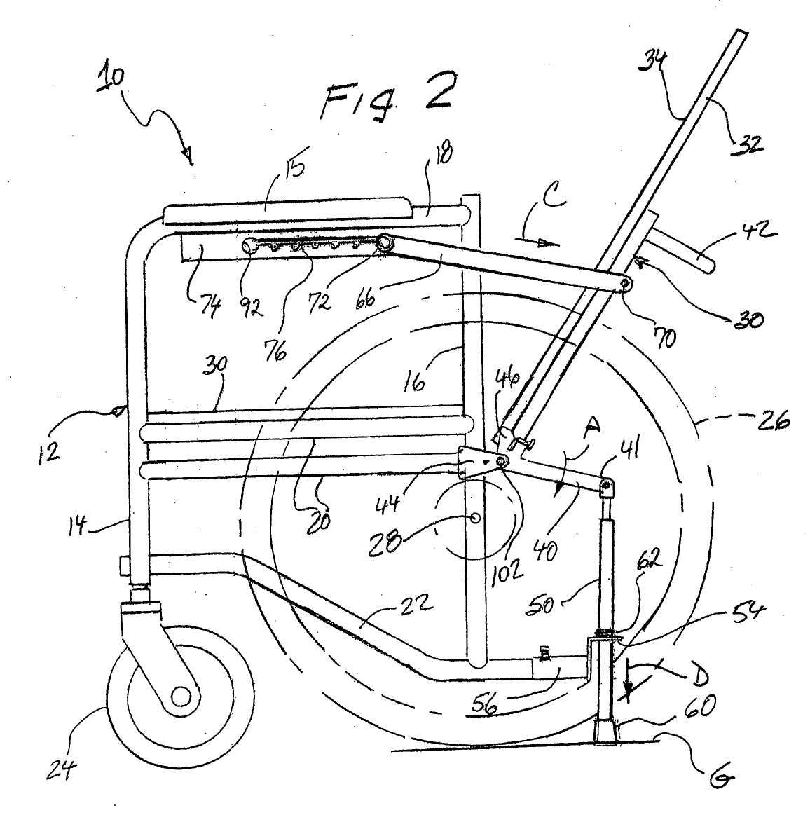

FIG. 6 shows how the backrest 32 is supported on linkage arm 40 for pivotal movement relative to the wheelchair frame 12. A mounting tab 100 extends from each end of the cross rail 38, as best seen in FIG. 3, and is received in slot 48 of linkage arm 40. The linkage arm 40 is mounted on pivot pin 102 to mounting plate 44. The linkage arm 40 pivots in a vertical plane relative to wheelchair frame 12 as indicated by arrow A in FIG. 3, thereby causing backrest 32 to pivot between an upright position illustrated in FIG. 1 and a reclined position shown in FIG. 2, as suggested by arrow B in FIG. 3 and arrow C in FIGS. 2 and 3. Pivotal movement of the linkage arm 40 also moves the anti tip leg 50 up and down as suggested by arrow D in FIGS. 2 and 3 between an elevated or retracted position of the leg 50 shown in FIG. 1 and a ground contacting extended position seen in FIG. 2. The length of leg 50 is such that in the retracted position of FIG. 1, the tip 60 is retracted to a position within the envelope of rear wheel 26 such that the tip of the leg does not interfere with displacement of the wheelchair, for example, while descending a step. In FIG. 2, the tip 60 rests upon a ground surface G under rear wheel 26 and makes contact with ground surface G at a location behind the rear wheel axis 28 so as to provide support against rearward tipping of wheelchair 10 which might result from loading of the reclined seat back 32. The length of leg 50 can be made adjustable by providing a rod 50a threaded into leg tube 50b. Rod 50a is fixed against rotation about its long axis to linkage arm 40, while tube 50b can be turned about its long axis such that it is displaced up or down along rod 50a, thereby adjusting the height of tip 60 above ground surface G.

A lockdown screw 104 is threaded in linkage arm 40 transversely to tab 100 and can be manually turned into an advanced position for closing the receiving slot 48 so as to capture tab 100 and secure the backrest 32 to the linkage arm 40. In the case where the wheelchair has a folding frame 12 the frame can be folded after removing the backrest 30. The screw 104 when retracted as in FIG. 6 frees the tab 100 for withdrawal from slot 48 as suggested by arrow E, and pin 70 is withdrawn to free the backrest from detent arms 66. Folding of the wheelchair frame 12 does not require removal of the linkage arm 40 or the anti-tip leg 50 on each side of the wheelchair frame.

The leg spring 62, in biasing the leg 50 towards its elevated, retracted position also operates to urge linkage arm 40 to an elevated position corresponding to an upright position of the backrest 30. In this manner, leg springs 62 on the two legs 50 operate to return the backrest 30 to an upright position, the detent arm 66 to a forwardmost position, and the legs 50 to a retracted condition.

A person sitting in wheelchair 10 can operate the reclining backrest 30 by grasping the handle 90 under the left arm rest 15 of the wheelchair, lifting the handle slightly to free the detent pin 82 from detent notch 78, and pushing against the seat back 32 sufficiently to overcome the bias of springs 62 until the backrest is angled to a desired reclining position, and then lowering the detent pin 82 into a detent notch 78 most closely corresponding to the desired angle of backrest 32. Elevation of the seat back is accomplished by freeing the detent arm from the detent notches 78 and allowing the springs 62 to raise the backrest 30 to its upright position of FIG. 1.

The reclining backrest with anti-tip protection of this invention can be retrofitted onto existing wheelchair frames without permanent modification to the wheelchair. The detent tube 80 can be attached to arm rest tube 88 of an existing wheelchair frame using screws normally provided through armrest tube 88 for fastening the armrest pad 15 to tube 18. Such screws have screw heads underneath tube 18 and thread upwardly into the bottom of the armrest pad 15. The detent tube 80 can be provided with screw holes (not shown) in its upper side 81 and aligned openings (not shown) in its bottom side 82 so as to allow insertion of a screwdriver into tube 80 for tightening of screws through side 81 and through armrest tube 18 into armrest pad 15. The mounting plate 44 may be one of a pair of such plates parallel to each other and tightened by means of bolts 45 so as to capture between them the T-joint of frame tubes 16 and 20.

In the presently preferred form of the invention a single detent arm 66 with one corresponding handle 90 is provided, so that the seat back position can be adjusted with one hand by the wheelchair occupant. It is also contemplated, however, that the seat back reclining mechanism of this invention could be provided with a pair of left and right detent arms 66, one detent arm along each arm rest, each with a corresponding detent plate 74, the two detent arms and detent plates being essentially mirror images of each other.

While a particular embodiment of the invention has been described and illustrated for purposes of clarity and example, many changes, substitutions and modifications to the described embodiment will be apparent to those having only ordinary skill in the art without thereby departing from the scope of this invention, which is defined by the following claims.

What is claimed as new is:

1. A wheelchair having a wheelchair frame including a seat supported on said frame and a backrest pivotable on said frame between an upright position and a reclined position, a pair of rear wheels journaled to said frame for rotation about a rear wheel axis, and anti-tip legs attached to said frame and movable between a retracted position and a ground contacting extended position responsive to pivoting movement of said backrest; and
a detent arm connected to said backrest and having a forward end located forwardly of said backrest such that an occupant seated in said wheelchair can hold said forward end for adjusting said backrest between said upright position and said reclined position.

2. The wheelchair of claim 1 wherein there are two anti-tip legs.

3. The wheelchair of claim 1 wherein said legs are arranged for contacting a ground surface behind said rear wheel axis.

4. The wheelchair of claim 1 said legs are mounted for generally vertical sliding movement on said frame and said backrest has linkage arms connected for urging said legs downwardly into said ground contacting position responsive to rearward pivoting of said backrest.

5. The wheelchair of claim 4 wherein said legs are vertically slidable through leg holders fastened to said wheelchair frame.

6. The wheelchair of claim 5 wherein said leg holders are removably fastened to said wheelchair frame.

7. The wheelchair of claim 6 wherein said wheelchair frame has a pair of bottom tubes terminating in rear ends behind said rear wheel axis and said leg holders are fastened to said rear ends.

8. The wheelchair of claim 7 wherein said leg holders comprise holder sleeves fitted to said rear ends and sleeve fasteners for securing said holder sleeves to said rear ends.

9. The wheelchair of claim 1 further comprising a mounting plate fastened to each side of said wheelchair frame, a linkage arm pivoted to each said mounting plate, wherein said backrest is supported on each said linkage arm for pivotal movement therewith relative to said wheelchair frame, and each linkage arm is connected for moving said legs between said retracted position and said extended position responsive to pivoting movement of said backrest.

10. The wheelchair of claim 1 further comprising a handgrip on said forward end.

11. The wheelchair of claim 1 further comprising a spring connected for urging said detent arm into engagement with said detent notches.

12. The wheelchair of claim 1 wherein said legs are spring loaded towards said retracted position.

13. The wheelchair of claim 1 wherein said legs and said backrest are spring loaded towards a retracted and upright position respectively.

14. The wheelchair of claim 1 further comprising spring means urging said legs towards said retracted position and wherein said backrest has a pair of linkage arms connected to said anti-tip legs for depressing said anti tip legs into said ground contacting position responsive to reclining movement of said backrest.

15. The wheelchair of claim 1 wherein said wheelchair frame has a pair of armrests and a detent plate under one of said armrests, said detent plate having a slot including a plurality of detent notches open to said slot, wherein said detent arm is attached to said backrest at one end and captive at another end for displacement along said slot, said other end being engageable in any one of said detent notches for detaining said backrest at one or more positions intermediate to said upright position and said reclined position.

16. The wheelchair of claim 15 further comprising a spring connected between said detent arm and said detent plate for urging said other end into engagement with said detent notches.

17. The wheelchair of claim 1 wherein said reclining backrest is removably attached to said wheelchair frame such that said reclining backrest is interchangeable with a non-reclining backrest.

18. A wheelchair having a wheelchair frame including a seat supported on said frame and a backrest pivotable on said frame between an upright position and a reclined position, a pair of armrests on left and right sides of said seat, a pair of rear wheels journaled to said frame for rotation about a rear wheel axis, a pair of anti-tip legs attached to said frame and movable between a retracted position and an extended position for contacting a ground surface behind said rear wheel axis responsive to pivoting movement of said backrest, a handgrip supported near one of said armrests forwardly of said backrest, said handgrip connected to said backrest such that a person seated in said wheelchair may operate said handgrip for pivoting said backrest between said upright position and said reclined position.

19. The wheelchair of claim 18 further comprising a detent arm connecting said handgrip to said backrest.

20. The wheelchair of claim 18 wherein said wheelchair frame has a detent plate along one of said armrests, said detent plate having a slot including a plurality of detent notches open to said slot, said handgrip being engageable in any one of said detent notches for detaining said backrest at one or more positions intermediate to said upright position and said reclined position.

21. The wheelchair of claim 18 wherein said legs are mounted for generally vertical movement on said frame, said backrest is connected for urging said legs downwardly into said ground contacting position responsive to rearward pivoting of said backrest, and said backrest and said legs are spring loaded towards said upright position and said retracted position respectively.

22. The wheelchair of claim 21 wherein said legs are adjustable in length.

23. The wheelchair of claim 18 wherein said reclining backrest is removably attached to said wheelchair frame such that said reclining backrest is interchangeable with a non-reclining backrest.

24. A wheelchair having a wheelchair frame including a seat supported on said frame and a backrest pivotable on said frame between an upright position and a reclined position, a pair of rear wheels journaled to said frame for rotation about a rear wheel axis, a pair of anti-tip legs attached to said frame and movable between a retracted position and an extended position for contacting a ground surface behind said rear wheel axis responsive to pivoting movement of said backrest;
a pair of armrests on said wheelchair frame and a detent plate along at least one of said armrests, said detent plate having a slot including a plurality of detent notches open to said slot, said backrest having a detent arm for said detent plate attached to said backrest and captive at a forward end thereof for displacement along said slot, said forward end being engageable in any one of said detent notches for detaining said backrest at one or more positions intermediate to said upright position and said reclined position; and a handgrip on said forward end.

25. The wheelchair of claim 24 further comprising a pair of linkage arms pivoted to said wheelchair frame, said backrest being supported on said linkage arms for pivotal movement therewith relative to said wheelchair frame, and wherein said linkage arms are connected for moving said legs between said retracted position and said extended position responsive to pivoting movement of said backrest.

26. The wheelchair of claim 24 wherein said backrest, said legs and said detent arm are spring biased towards said upright position, said retracted position and a forwardmost position, respectively.

27. The wheelchair of claim 24 wherein said reclining backrest is removably attached to said wheelchair frame such that said reclining backrest is interchangeable with a non-reclining backrest.

28. A wheelchair having a wheelchair frame including a seat supported on said frame and a backrest pivotable on said frame between an upright position and a reclined position, a pair of rear wheels journaled to said frame for rotation about a rear wheel axis, and one or more anti-tip legs attached to said frame and mounted for generally vertical movement on said frame between a retracted position and a ground contacting extended position responsive to pivoting movement of said backrest.

29. The wheelchair of claim 28 wherein said legs are vertically slidable through leg holders fastened to said wheelchair frame.

30. The wheelchair of claim 28 wherein said leg holders are removably fastened to said wheelchair frame.

31. The wheelchair of claim 30 wherein said wheelchair frame has a pair of bottom tubes terminating in rear ends behind said rear wheel axis and said leg holders are fastened to said rear ends.

32. The wheelchair of claim 31 wherein said leg holders comprise holder sleeves fitted to said rear ends and sleeve fasteners for securing said holder sleeves to said rear ends.

33. The wheelchair of claim 28 further comprising a mounting plate fastened to each side of said wheelchair frame, a linkage arm pivoted to each said mounting plate, wherein said backrest is supported on each said linkage arm for pivotal movement therewith relative to said wheelchair frame, and each linkage arm is connected for moving said legs between said retracted position and said extended position responsive to pivoting movement of said backrest.

34. The wheelchair of claim 28 wherein said reclining backrest is removably attached to said wheelchair frame such that said reclining backrest is interchangeable with a non-reclining backrest.

35. The wheelchair of claim 28 wherein said wheelchair frame has a pair of armrests and a detent plate under one of said armrests, said detent plate having a slot including a plurality of detent notches open to said slot, a detent arm attached to said backrest at one end and captive at another end for displacement along said slot, said other end being engageable in any one of said detent notches for detaining said backrest at one or more positions intermediate to said upright position and said reclined position.

36. The wheelchair of claim 28 wherein said legs have tips adjustable in height relative to a ground surface.
